(19) United States
(12) Patent Application Publication
(10) Pub. No.: US 2023/0370461 A1
(43) Pub. Date: Nov. 16, 2023

(54) INTERCLOUD SERVICE GATEWAY

(71) Applicant: Oracle International Corporation, Redwood Shores, CA (US)

(72) Inventors: Harshit Kumar Kalley, Sunnyvale, CA (US); Srikanth Vavilapalli, Dublin, CA (US)

(73) Assignee: Oracle International Corporation, Redwood Shores, CA (US)

(21) Appl. No.: 17/742,472

(22) Filed: May 12, 2022

(51) Int. Cl. H04L 9/40

(52) U.S. Cl. CPC H04L 63/10; H04L 63/126

(57) ABSTRACT

Discussed herein is a framework that facilitates access to services offered in a target cloud environment for resources deployed in a source cloud environment. The source cloud environment is different and independent with respect to the target cloud environment. A compute instance executed in a source cloud environment generates a request to use a service provided in the target cloud environment. The request is transmitted from the source cloud environment to the target cloud environment via an intercloud service gateway. The service is executed in the target cloud environment based on an access role that is associated with the compute instance.

### FIELD

The present disclosure relates to an intercloud service gateway that provides a framework facilitating access to services offered in a first cloud environment (e.g., a first public cloud) for resources deployed in a second cloud environment (e.g., a second public cloud). The access to services is offered without exchanging or sharing identity principals (e.g., certificates or credentials) associated with the resources between the two cloud environments.

### BACKGROUND

Users or customers of a public cloud want to access best in-class services from various cloud service providers. In the cloud environment, a current paradigm of such a service design incentivizes building on top of local services offered by the cloud environment. Cross-cloud or inter cloud service access is not readily available. As such, users design their own bespoke solutions to access, from a first cloud environment, services offered in a second cloud environment that is different and independent from the first cloud environment. Typical solutions that are designed to gain access to services offered by another cloud service provider are time consuming, error prone and expensive. Moreover, one of the major downsides of typical access solutions is that of credential management. Specifically, accessing services offered in a first cloud environment, from resources deployed in a second cloud environment, involves setting up network connectivity between the two cloud environments. In such a framework, accessing services of the first cloud environment involves users distributing their credentials over cloud infrastructures. Such a solution is inherently insecure and inconvenient.

Embodiments described herein address these and other issues related to migrating applications between different cloud environments.

### SUMMARY

The present disclosure relates generally to an intercloud service gateway that provides a framework facilitating access to services offered in a first cloud environment (e.g., a first public cloud) for resources deployed in a second cloud environment (e.g., a second public cloud). The access to services is offered without exchanging or sharing identity principals (e.g., certificates or credentials) associated with the resources between the two cloud environments. Various embodiments are described herein, including methods, systems, non-transitory computer-readable storage media storing programs, code, or instructions executable by one or more processors, and the like. These illustrative embodiments are mentioned not to limit or define the disclosure, but to provide examples to aid understanding thereof. Additional embodiments are discussed in the detailed description section, and further description is provided therein.

An aspect of the present disclosure provides for a method comprising: generating, by a compute instance executed in a source cloud environment, a request to use a service provided in a target cloud environment, the source cloud environment being different than the target cloud environment; transmitting the request from the source cloud environment to the target cloud environment via an intercloud service gateway; and executing the service in the target cloud environment based on an access role associated with the compute instance.

Another aspect of the present disclosure provides for a computer readable medium storing specific computer-executable instructions that, when executed by a processor, cause a computer system to at least: generating, by a compute instance executed in a source cloud environment, a request to use a service provided in a target cloud environment, the source cloud environment being different than the target cloud environment; transmitting the request from the source cloud environment to the target cloud environment via an intercloud service gateway; and executing the service in the target cloud environment based on an access role associated with the compute instance.

One aspect of the present disclosure provides for a system comprising a processor, and a memory including instructions that, when executed with the processor, cause the system to, at least: generate, by a compute instance executed in a source cloud environment, a request to use a service provided in a target cloud environment, the source cloud environment being different than the target cloud environment; transmit the request from the source cloud environment to the target cloud environment via an intercloud service gateway; and execute the service in the target cloud environment based on an access role associated with the compute instance.

The foregoing, together with other features and embodiments will become more apparent upon referring to the following specification, claims, and accompanying drawings.

### BRIEF DESCRIPTION OF THE DRAWINGS

FIG. 1 depicts an exemplary high-level architecture of an intercloud service gateway (ICSGW), in accordance with various embodiments.

FIG. 2 depicts a flow diagram illustrating a process performed by the intercloud service gateway (ICSGW), in accordance with various embodiments.

FIG. 3A depicts a detailed architecture of the intercloud service gateway (ICSGW), in accordance with various embodiments.

FIG. 3B depicts a flow diagram illustrating a process performed by a source intercloud service gateway, in accordance with certain embodiments.

FIG. 3C depicts a flow diagram illustrating a process performed by a target intercloud service gateway, in accordance with certain embodiments.

FIG. 4A depicts an exemplary process of compute instances executed in a source cloud environment utilizing services offered in a target cloud environment, in accordance with some embodiments.

FIG. 4B depicts another exemplary process of compute instances executed in a source cloud environment utilizing services offered in a target cloud environment, in accordance with some embodiments.

FIG. 5 is a block diagram illustrating one pattern for implementing a cloud infrastructure as a service system, according to at least one embodiment.

FIG. 6 is a block diagram illustrating another pattern for implementing a cloud infrastructure as a service system, according to at least one embodiment.

FIG. 7 is a block diagram illustrating another pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

In cloud computing, a cloud is a collection of servers that cloud customers access over a communication network e.g., the Internet. A cloud service provider (CSP) that offers a variety of services for the customers manages the infrastructure of a cloud. In contrast, a multi-cloud environment in general relates to the use of several cloud infrastructures, each of which is managed by a unique CSP. Multi-cloud deployments have a number of uses. A multi-cloud deployment can leverage multiple Infrastructure-as-a-Service (IaaS) vendors, or it could use a different vendor for IaaS, Platform-as-a-Service (PaaS), and Software-as-a-Service (SaaS) services. Multi-cloud can be purely for the purpose of redundancy and system backup, or it can incorporate different cloud vendors for different services.

To date, most multi-cloud solutions have primarily focused on simplifying network access. Users or customers that have accounts with different CSPs, can access resources in the different clouds based on identity federation i.e., user's identity federation. Specifically, identity federation is a system of establishing trust between two parties for the purpose of authenticating users and conveying information needed to authorize their access to resources. However, such a framework does not naturally extend to establishing trust between resources (i.e., non-user actors, such as compute instances, VMs, functions).

Furthermore, as much as possible, customers prefer to keep their traffic from compute workloads (i.e., VMs, containers, functions) to cloud services private and prefer to avoid distribution of their long-lived credentials into these compute workloads. Customers may achieve this type of communication but only within the respective cloud provided environments i.e., in a single cloud environment. Currently there are no mechanisms to achieve the similar communication mode in an inter-cloud environment. Embodiments of the present disclosure provide for an Inter Cloud Service Gateway (ICSGW) that aims to offer a framework using which customers can configure their compute workloads or compute instances in one cloud environment (e.g., managed by a first CSP) to access services in a different cloud environment (i.e., managed by a second CSP) in a more secure manner.

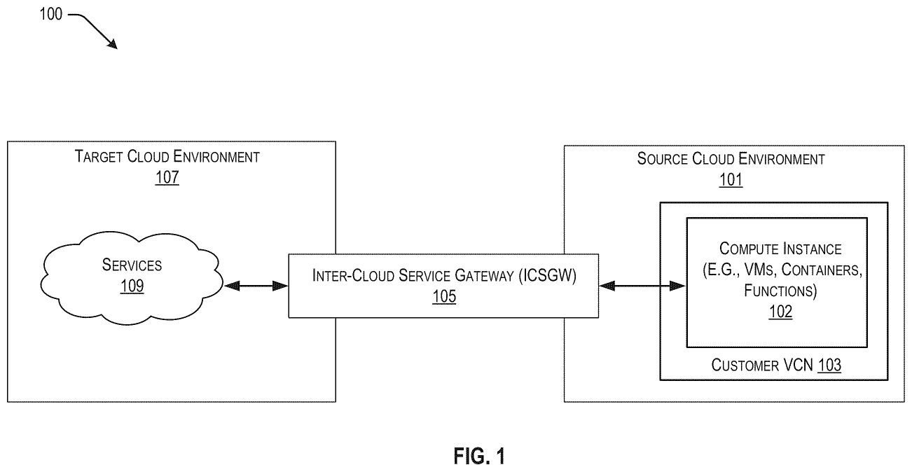

FIG. 1 depicts an exemplary high-level architecture of an intercloud service gateway (ICSGW) in accordance with various embodiments. The high-level architecture 100 depicted in FIG. 1 includes the intercloud service gateway 105 that is a multi-tenant service disposed seamlessly between a source cloud environment 101 and a target cloud environment 107. Specifically, the ICSGW 105 has a footprint in both the source cloud environment 101 and the target cloud environment 107.

The source cloud environment 101 includes one or more customer virtual cloud networks (e.g., customer VCN 103) that hosts one or more compute instances 102 (e.g., virtual machines (VMs), containers, functions). Such compute instances 102 may avail of services 109 offered by the target cloud environment 107 via the ICSGW 105. It is appreciated that the services 109 offered by the target cloud environment 107 may be availed by customers who have a tenancy (i.e., customer account in the target cloud environment 107), as well as customers who do not have a customer tenancy in the target cloud environment 107.

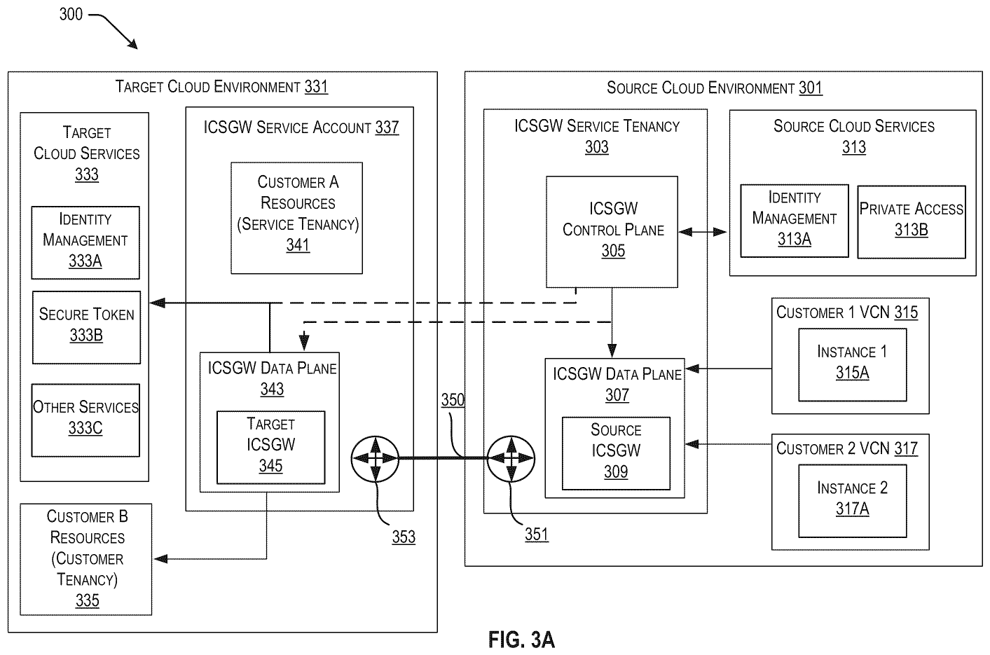

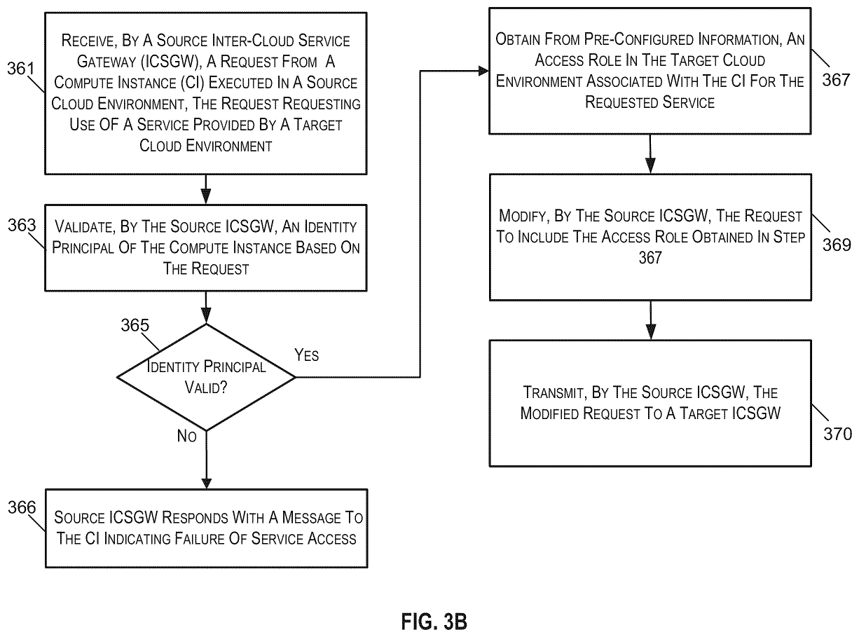

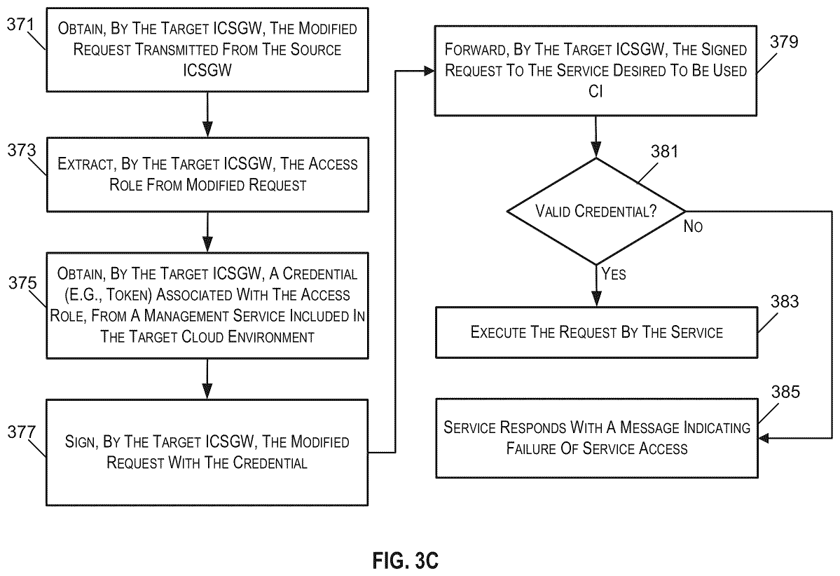

According to some embodiments, when compute workloads (e.g., compute instances 102 in the source cloud environment 101) access the target services 109 in the target cloud environment, with the identity principals (i.e., resource principals corresponding to an identity of the resource) available locally in source cloud environment 101, the ICSGW 105 service performs a set of actions. In one implementation, the set of actions includes at least: (i) intercepts the requests/responses between compute workloads and target services, (ii) validates identity principal associated with the compute instances, (iii) translates the identity principal to an access role of the compute instance in the target cloud environment, and (iv) forwards the request to a final destination (e.g., desired service) in the target cloud environment. In other words, a compute instance 102 in the source cloud environment generates a request to access a service 109 in the target cloud environment. The request is further communicated over a secure communication channel from the source cloud environment 101 to the target cloud environment 107. The service is executed in the target cloud environment 107 based on an access role (i.e., one or more privileges) associated with the compute instance in the source cloud environment 101. Further, details pertaining to the architecture of the ICSGW 105, as well as the process of initiating a service (in a target cloud environment) for use by a compute instance in the source cloud environment are described in detail below with reference to FIGS. 3A to 3C.

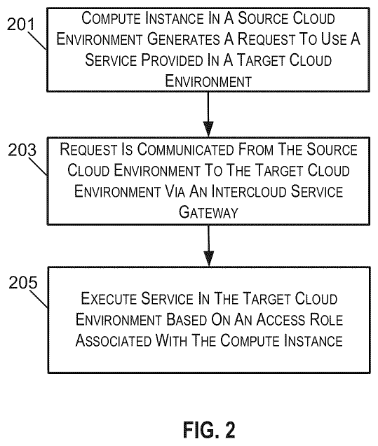

FIG. 2 depicts a high-level flow diagram illustrating a process performed by the intercloud service gateway (ICSGW) in accordance with various embodiments. Specifically, FIG. 2 depicts a process illustrating the steps that provision for a compute instance (e.g., a virtual machine, container, function) executed in a source cloud environment to access services provided in a target cloud environment via the ICSGW. The processing depicted in FIG. 2 may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 2 and described below is intended to be illustrative and non-limiting. Although FIG. 2 depicts the various processing steps occurring in a particular sequence or order, this is not intended to be limiting. In certain alternative embodiments, the steps may be performed in some different order or some steps may also be performed in parallel.

The process commences at step 201, where a compute instance that is executed in a source cloud environment (e.g., a compute instance that is executed in a customer VCN in the source cloud environment) generates a request to use a service provided in a target cloud environment. It is noted that target cloud environment is different and indepedent from the source cloud envirionment.

In step 203, the request generated by the compute instance is communicated from the source cloud environment to the target cloud environment via an intercloud service gateway. Specifically, as will be described later with reference to FIG. 3A, the request is communicated from a source intercloud service gateway (deployed in the source cloud environment) to a target intercloud service gateway (deployed in the target cloud environment) that are communicateively coupled via a trusted communication channel (e.g., a Fastconnect communication channel). Upon the request being transmitted to the target cloud environment, in step 205, the service is executed in the target cloud environment based on an access role that is associated with the compute instance.

Turning now to FIG. 3A, there is depicted a detailed architecture of the intercloud service gateway (ICSGW) in accordance with various embodiments. The ICSGW provides a framework of services that facilitate access to services offered in a first public cloud (i.e., referred to herein as a target cloud environment) for resources deployed in a second public cloud (i.e., referred to herein as source cloud environment) without sharing identity principals across the two cloud environments.

The architecture 300 of the ICSGW includes a source cloud environment 301 and a target cloud environment 331. The source cloud environment 301 includes an ICSGW service tenancy 303, source cloud services 313, and one or more customer virtual cloud networks (VCNs) (e.g., customer 1 VCN 315, customer 2 VCN 317). The ICSGW service tenancy 303 includes a control plane component (i.e., ICSGW control plane 305), and a data plane component (i.e., ICSGW data plane 307). A source ICSGW 309 is hosted in the ICSGW data plane 307. The source cloud services 313 include a plurality of services including an identity and management service 313A, and a private access service 313B. Each of the customer VCNs includes a compute instance that is executed therein (e.g., customer 1 VCN 315 includes a compute instance 315A and customer 2 VCN 317 includes another compute instance 317A).

The target cloud environment 331 includes a ICSGW service account (or service tenancy) 337 and target cloud services 333. The ICSGW service account 337 includes a data plane component (i.e., ICSGW data plane 343) that hosts a target ICSGW 345. The target cloud services may include services, such as identity management 333A, a secure token service 333B, and other services 333C (e.g., a queue service, a storage service). The source cloud environment 301 is communicatively coupled to the target cloud environment 331 via a trusted, high-bandwidth and low-latency communication link 350 (e.g., a FastConnect communication link). Specifically, by one embodiment, the trusted communication link 350 is established by connecting the source ICSGW 309 (disposed in the data plane 307 of the source cloud environment 301) to the target ICSGW 345 (disposed in the data plane 343 of the target cloud environment 331) via a pair of routers (e.g., fast connect enabled dynamic routing gateways (DRGs)). For example, as shown in FIG. 3A, the ICSGW service tenancy 303 in the source cloud environment 301 includes a first fast connect enabled DRG 351 that is communicatively coupled to a second fast connect enabled DRG 353, which is included in the ICSGW service tenancy 337 of the target cloud environment 331.

The source ICSGW 309 in conjunction with the target ICSGW 345 provide a framework that facilitate compute instances that are executed in the source cloud environment 301 (e.g., compute instances 315A and 317A) to access services (e.g., other services 333C) offered in the target cloud environment 331. It is appreciated that the services offered in the target cloud environment 331 are available for customers of the source cloud environment 301 that have a tenancy (or account) in the target cloud environment 331 (e.g., customer B tenancy 335), as well as for customers of the source cloud environment 301 that do not have a tenancy in the target cloud environment. It is noted that for customers that do not have a tenancy in the target cloud environment 331, the ICSGW control plane 305 of the source cloud environment 301 is configured to instantiate a resource group for the customer in the ICSGW service account 337 of the target cloud environment (e.g., customer A resource group). The resource group includes resources such as queues, storage buckets, access roles, etc. It is appreciated that the above described embodiment of FIG. 3A is in no way limiting the scope of the present disclosure. Rather, modifications to the architecture of the intercloud service gateway (ICSGW) are well within the scope of the present disclosure. For instance, according to some embodiments, the ICSGW data plane 307 (in the source cloud environment 301) may include a pool of source ICSGWs, and the ICSGW data plane 343 (in the target cloud environment 331) may include a pool of target ICSGWs. In such a setting, one source ICSGW from the pool of source ICSGWs, as well as one target ICSGW from the pool of target ICSGWs may be selected dynamically based on certain conditions (e.g., a current traffic load in the system) to transmit the request from the source cloud environment 301 to the target cloud environment 331.

In what follows, there is provided a detailed description as to how a resource executed in a source cloud environment (e.g., compute instance 315A) accesses services in the target cloud environment 331. In operation, the process of facilitating access to services in the target cloud environment 331 to resources in the source cloud environment 301 includes two phases of operations: a set-up phase and an execution phase. In the set-up phase, dynamic groups are created in the source cloud environment. Dynamic groups provide for grouping of compute instances as principal actors in a manner similar to grouping users into user groups. Policies are created in the set-up phase that permit compute instances within a dynamic group to issue API calls for obtaining services from the target cloud environment. Membership in a dynamic group may be determined by a set of criteria referred to as matching rules. Cloud infrastructure resources (e.g., compute instances) that satisfy the matching rules are included as members of a dynamic group.

Further, in the set-up phase, each dynamic group is assigned a role (referred to herein as an access role) that corresponds to a set of privilages that members of the dynamic group may assume in the target cloud environment. Additionally, in the set-up phase, the customer may provide information pertaining to whether the customer has a tenancy (i.e., account) in the target cloud environment. Such information may include an identifier of the target cloud environment, a region of the target cloud environment, an account ID for the customer's tenancy in the target cloud environment, etc. It is appreciated that in case the customer does not have a tenancy in the target cloud environment, the ICSGW control plane 305 (included in the source cloud environment 301) may establish a resource group for the customer (e.g., customer A resource group 341) in the set-up phase. It is noted that the resource group is created in the ICSGW service account 337 of the target cloud environment 331.

According to some embodiments, in the set-up phase, the ICSGW control plane 305 of the source cloud environment 301 utilizes the private access service 313B to provide private connectivity between customer VCNs in customer tenancies of the source cloud environment (e.g., customer 1 VCN 315, customer 2 VCN 317) to the ICSGW data plane 307. Furthermore, the ICSGW control plane 305 may utilize a VCN/DNS infrastucture service to program a domain name system (DNS) resolver in the customer VCN to re-route the customer traffic destined for services in the target cloud environment to the ICSGW data plane 307.

In the execution phase, a compute instance that is executed in a customer VCN (e.g., compute instance 315A) transmits a request, requesting use of a service provided in the target cloud environment 331. Such a request is intercepted by the source ICSGW 309. In one implementation, the request includes an identity principal (e.g., a certificate or credential) associated with the compute instance. The source ICSGW extracts the identity principal from the request and performs a validation of permission associated with the compute instance. For instance, the source ICSGW 309 communicates with the identity management service 313A of the source cloud environment 301 to verify whether the particular compute instance is permitted to issue a request, requesting services offered by a target cloud environment.

Upon successful validation, the source ICSGW 309 obtains an access role that is pre-configured for the compute instance (i.e., in the set-up phase). The source ICSGW 309 then modifies the request received from the compute instance and forwards the modified request to the target ICSGW 345 included in the target cloud environment. Note that the modified request is communicated from the source cloud environment 301 to the target cloud environment over the trusted communication channel (e.g., communication channel 350) established in the set-up phase. In one implementation, the source ICSGW 309 modifies the request by stripping off (i.e., removing) the identity principal from the request and incorporating the access role in the request to form a modified request. In this manner, it is ensured that identity principals associated with the resources of the source cloud environment 301 are not transmitted to the target cloud environment 331.

The target ICSGW 345 upon receiving the modified request that is transmitted by the source ICSGW 309 extracts the access role (associated with the compute instance) included in the modified request. In one embodiment, the target ICSGW 345 communicates with a management service (e.g., identity management service 333A or secure token service 333B included in the target cloud environment 331) to obtain a credential (e.g., token) associated with the access role of the compute instance. The target ICSGW 345 signs the modified request with the obtained credential and forwards the signed reqeust to the service (e.g., service 333C) that is desired to be used by the compute instance. In one embodiment, the desried service may communicate with the management service (e.g., identity management service 333A) of the target cloud environment 331 to determine whether the credential used to sign the request has sufficient privilages to perform a requested action. Upon successful validation, the service is executed in customer tenancy included in the target cloud environment 331, i.e., the request is executed in the customer B tenancy 335 (in case the customer has a tenancy in the target cloud environment), or the request is executed in customer A resource group 341 (in case the customer does not have its own tenancy in the target cloud environment).

FIG. 3B depicts a flow diagram illustrating a process performed by a source intercloud service gateway (ICSGW) in accordance with certain embodiments. The processing depicted in FIG. 3B may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 3B and described below is intended to be illustrative and non-limiting. Although FIG. 3B depicts the various processing steps occurring in a particular sequence or order, this is not intended to be limiting. In certain alternative embodiments, the steps may be performed in some different order or some steps may also be performed in parallel.

The process commences in step 361, where the source ICSGW receives a request from a compute instance executed in a source cloud environment. The request corresponds to the compute instance requesting use of a service provided by a target cloud environment. In one implementation, the request includes an identity principal (e.g., a certificate or credential) associated with the compute instance. In step 363, the source ICSGW extracts the identity principal from the request and performs a validation of permission associated with the compute instance. For example, the source ICSGW verifies whether the particular compute instance is permitted to issue a request, requesting services offered by a target cloud environment.

In step 365, the source ICSGW executes a query to determine whether the validation of permission associated with the identity principal associated with the compute instance is successful. If the response to the query is affirmative (i.e., the compute instance is permitted to request for services offered by the target cloud environment), then the process moves to step 367. However, if the response to the query in step 365 is negative (i.e., the compute instance is not permitted to request for services offered by the target cloud environment), then the process moves to step 366. It is appreciated that the source ICSGW may validate the identity principal associated with the compute instance in accordance with a management service of the source cloud environment (e.g., identity access management service).

In step 366 (i.e., upon determining a negative response to the query of step 365), the source ICSGW provides a response to the request transmitted by the compute instance. For example, source ICSGW transmits a response message to the compute instance indicating that the identity principal of the compute instance was not successfully validated, and thus the requested service of the target cloud environment cannot be provided to the compute instance (i.e., a failure of service access). Upon transmitting the response message in step 366, the process in FIG. 3A terminates.

Upon determining a positive response to the query of step 365, the process moves to step 376. In this step, the source ICSGW obtains from pre-configured information (e.g., information associated with the set-up phase), an access role associated with the compute instance for the requested service. The access role indicates privileges (e.g., read-write privilege, read only privilege) associated with the compute instance in the target cloud environment.

The process then proceeds to step 369, where the source ICSGW modifies the request obtained from the compute instance to generate a modified request. In one implementation, the source ICSGW removes the identity principal associated with the compute instance from the request and includes the access role (obtained in step 367) associated with the compute instance in the request to generate the modified request. Thereafter, the source ICSGW transmits the modified request to a target ICSGW. Referring to FIG. 3A, it is appreciated that the modified request is transmitted from the source ICSGW to the target ICSGW via the trusted communication channel 350 that is established between the source cloud environment and the target cloud environment.

FIG. 3C depicts a flow diagram illustrating a process performed by a target intercloud service gateway (ICSGW) in accordance with certain embodiments. The processing depicted in FIG. 3C may be implemented in software (e.g., code, instructions, program) executed by one or more processing units (e.g., processors, cores) of the respective systems, hardware, or combinations thereof. The software may be stored on a non-transitory storage medium (e.g., on a memory device). The method presented in FIG. 3C and described below is intended to be illustrative and non-limiting. Although FIG. 3C depicts the various processing steps occurring in a particular sequence or order, this is not intended to be limiting. In certain alternative embodiments, the steps may be performed in some different order or some steps may also be performed in parallel.

The process commences in step 371, where the target ICSGW receives the modified request transmitted by the source ICSGW (i.e., the request transmitted by the source ICSGW in step 370 of FIG. 3B). In step 373, the target ICSGW extracts the access role included in the modified request. The process then moves to step 375, where the target ICSGW communicates with a management service included in the target cloud environment (e.g., secure token service 333B of FIG. 3B). Specifically, the target ICSGW communicates with the management service to obtain a credential (e.g., token) associated with the access role of the compute instance.

In step 377, the target ICSGW proceeds to sign the modified request with the credential obtained in step 375 and forwards the signed reqeust to the service that is desired to be used by the compute instance in step 379. The process then moves to step 381, where a query is executed to determine validity of the credential. For instance, in one implementation, the desried service may communicate with the management service (e.g., identity management service) of the target cloud environment to determine whether the credential used to sign the request has sufficient privilages to perform a requested action. If the response to the query in step 381 is affirmative (i.e., the credential has sufficient privileges to perform the action), the process moves to step 383. However, if the response to the query of step 381 is negative, the process moves to step 385.

In step 385, the service responds with a message indicating failure of access to the requested action (e.g., read, write, update) to be performed by the service. In other words, the service notifies the target ICSGW that the requested action could not be performed due to insufficient privileges. In some implementations, the target ICSGW may forward the obtained response to the compute instance deployed in the source cloud environment via the trusted communication channel. However, in response to a successful validation of the credential in step 381, the process in step 383 proceeds to execute the request by the desired service. Thereafter, the process depicted in FIG. 3B terminates.

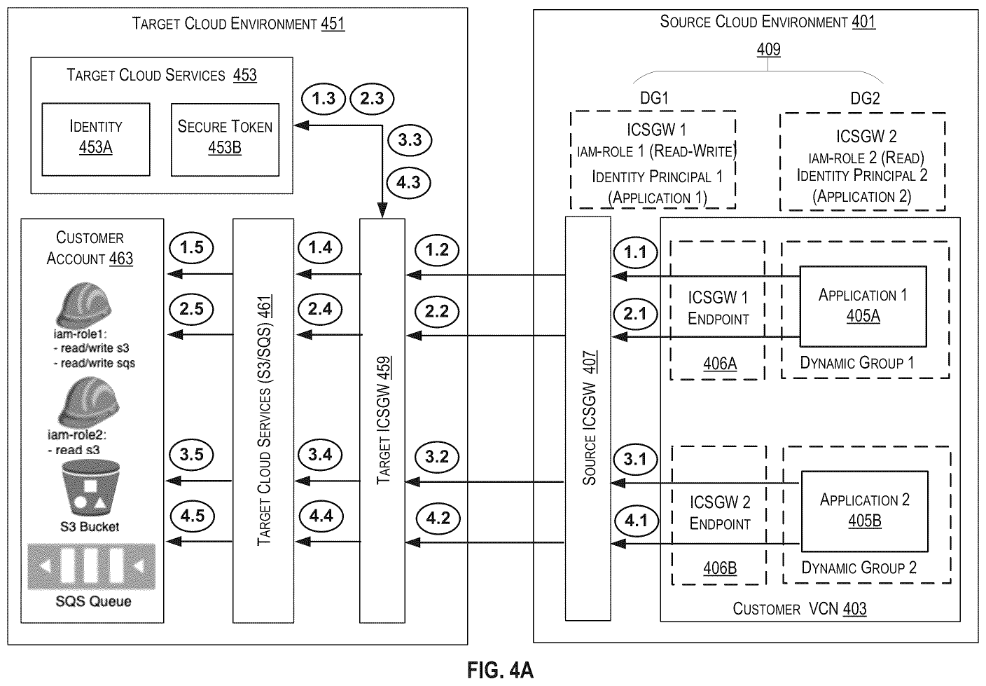

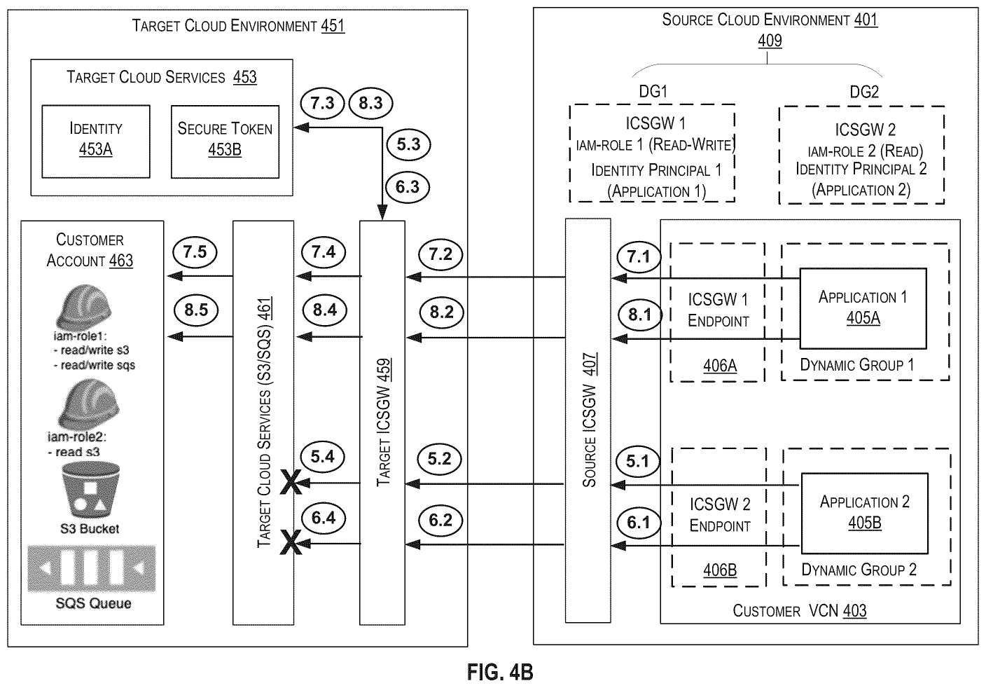

Turning now to FIG. 4A and FIG. 4B, there is depicted an exemplary process of compute instances executed in a source cloud environment utilizing services offered in a target cloud environment, in accordance with some embodiments. Referring to FIG. 4A, there is depicted a source cloud environment 401 and a target cloud environment 451. The source cloud environment 401 includes a customer virtual cloud network (i.e., customer VCN 403) that hosts two applications (i.e., application 1 405A and application 2 405B). Further, the source cloud environment 401 includes a source ICSGW 407 that is communicatively coupled with a target ICSGW 459 included in the target cloud environment 451.

The target cloud environment 451 includes target cloud services 461, a customer tenancy or account 463, and other target cloud services 453. The other target cloud services 453 may include additional services, such as an identity management service 453A, a secure token service 453B, and the like. For sake of illustration, the target cloud services 461 in the target cloud environment 451 that are desired to be utilized by the compute instances (i.e., application 1 405A and application 2 405B in the source cloud environment 401) are depicted as S3 and SQS services. The S3 service (i.e., simple storage service) is an object storage service that stores data as objects in buckets. An object is a file and any metadata that describes the file. A bucket is a container for the objects. SQS (i.e., simple queue service) is a managed message queuing service that is used to send, store, and retrieve multiple messages of various sizes asynchronously.

According to some embodiments, dynamic groups are created in the source cloud environment in a set-up phase. Dynamic groups provide for grouping of compute instances as principal actors in a manner similar to grouping users into user groups. Policies may be created in the set-up phase that permit compute instances within a dynamic group to issue API calls for obtaining services. It is appreciated that membership in a dynamic group may be determined by a set of criteria referred to as matching rules. Cloud infrastructure resources that satisfy the matching rules are included as members of a dynamic group. For instance, as shown in FIG. 4A, application 1 405A is included in a first dynamic group (DG1) whereas application 2 405B is included in a second dynamic group (DG2).

Further, in the set-up phase, each dynamic group may be assigned a role (also referred to herein as access role) that corresponds to a set of privilages that members of the dynamic group may assume in the target cloud environment. For example, as shown in FIG. 4A, application 1 405A that belongs to dynamic group 1 (DG1) is assigned a first role (labeled as IAM-Role 1) and application 2 405B that belongs to dynamic group 2 (DG2) is assigned a second role (labeled as IAM-Role 2). For sake of simplicity, the privilages associated with the first role correspond to read and write privilages, whereas the priviliges associated with the second role correspond to a read only privilege. The set of dynamic groups constructed in this manner are depicted in dotted boxes 409 in FIG. 4A. As shown in FIG. 4A, it is appreciated that the roles assigned to the different dynamic groups are also instantiated in the customer account 463 in the target cloud environment in the set-up phase. Specifically, in the set-up phase, the customer specifies as to whether or not the customer has customer tenancy in the target cloud environment. In the event the customer has a customer tenancy in the target cloud environment (e.g., customer account 463 in the target cloud environment 451), information specifying the target cloud environment, the customer tenancy in the target cloud environment, the different roles assigned to the dynamic groups of the customer VCN, etc., are specified in the set-up phase.

Further, by some embodiments, compute instances in each dynamic group may be programmed to send requests for services offered in a target cloud environment to an endpoint associated with the dynamic group. The endpoint forwards the requests to the source ICSGW, which further forwards the request to the target ICSGW via the secure communication channel. For example, as shown in FIG. 4A, application 1 405A included in DG1 forwards requests issued by the application (i.e., request requesting services offered in the target cloud environment) to ICSGW 1 endpoint 406A, whereas application 2 405B included in DG2 forwards requests issued by the application to ICSGW 2 endpoint 406B.

In what follows, with reference to FIG. 4A, there is described in detail flow pertaining to four different requests (for services offered by the target cloud environment) that are issued by compute instances included in the customer VCN 403. Specifically, flow 1 (having steps labeled 1.1 to 1.5) corresponds to the scenrio of application 1 405A issuing a request to access an S3 bucket in the target cloud environment to upload a file. Flow 2 (having steps labeled 2.1 to 2.5) corresponds to the scenrio of application 1 405A issuing a request to invoke SQS service to send a message. Flow 3 (having steps labeled 3.1 to 3.5) corresponds to the scenrio of application 2 405B polling the SQS queue to determine presence of a message, and flow 4 (having steps labeled 4.1 to 4.5) corresponds to the scenrio of application 2 405B issuing a request to read files.

Referring to flow 1, in step 1.1, application 1 405A issues a request to upload a file. The request is forwarded to the source ICSGW 407 via the ICSGW 1 endpoint 406A. The source ICSGW 407 terminates the request and performs a validation check to determine whether the identity principal associated with application 1 405A is permitted to make such a request. Upon successful validation, the source ICSGW 407 modifies the request to include the access role (e.g., IAM role 1) associated with application 1 405A in the request. The source ICSGW 407 forwards the modified request to the target ICSGW 459 in step 1.2. Note that the modified request is forwarded over the secure communication channel (e.g. FastConnect) established between the source cloud environment 401 and the target cloud environment 451. In step 1.3, the target ICSGW 459 extracts the corresponding access role from the modified request received from the source ICSGW 407. The target ICSGW 459 communicates with a management service (e.g., secure token service 453B included in the target cloud services 453) to obtain a credential associated with the access role. In step 1.4, the target ICSGW 459 signs the modified request with the obtained credentials (of step 1.3) and forwards the signed request to the service (e.g., service 461 that is desired to be used by application 1 405A). In step 1.5, the target service 461 may perform a check to determine whether the credential (obtained from the target ICSGW 459) is associated with sufficient privileges to perform the requested action (i.e., upload a file). Further, as application 1 405A is associated with the access role that has read and write priviliages, the file is uploaded in a S3 bucket in the customer's tenancy 463 in step 1.5.

Referring now to flow 2, in step 2.1, application 1 405A issues a request to invoke the SQS service in the target cloud environment to send a message (e.g., to an SQS queue). The request is forwarded to the source ICSGW 407 via the ICSGW 1 endpoint 406A. The source ICSGW 407 terminates the request and performs a validation check to determine whether the identity principal associated with application 1 405A is permitted to make such a request. Upon successful validation, the source ICSGW 407 modifies the request to include the access role (e.g., IAM role 1) associated with application 1 405A in the request. The source ICSGW 407 forwards the modified request to the target ICSGW 459 in step 2.2. In step 2.3, the target ICSGW 459 extracts the corresponding access role from the modified request received from the source ICSGW 407. The target ICSGW 459 communicates with the management service (e.g., secure token service 453B included in the target cloud services 453) to obtain a credential associated with the access role. In step 2.4, the target ICSGW 459 signs the modified request with the obtained credentials (of step 1.3) and forwards the signed request to the service (e.g., SQS service 461 that is desired to be used by application 1 405A). In step 2.5, the target service 461 may perform a check to determine whether the credential (obtained from the target ICSGW 459) is associated with sufficient privileges to perform the requested action (i.e., send a message on the SQS queue). Further, as application 1 405A is associated with the access role that has read and write priviliages, the message is added to the SQS queue in the customer's tenancy 463 in step 2.5.

Referring now to flow 3 that corresponds to the scenrio of application 2 405B polling the SQS queue to determine presence of a message (i.e., read a message from the SQS queue). In step 3.1, application 2 405B issues a request to fetch a message from the SQS queue. The request is forwarded to the source ICSGW 407 via the ICSGW 2 endpoint 406B. The source ICSGW 407 terminates the request and performs a validation check as described above. Upon successful validation, the source ICSGW 407 modifies the request to include the access role (e.g., IAM role 2) associated with application 2 405B in the request. The source ICSGW 407 forwards the modified request to the target ICSGW 459 in step 3.2. In step 3.3, the target ICSGW 459 extracts the corresponding access role from the modified request received from the source ICSGW 407. The target ICSGW 459 communicates with the management service to obtain a credential associated with the access role. In step 3.4, the target ICSGW 459 signs the modified request with the obtained credentials (of step 3.3) and forwards the signed request to the service (e.g., SQS service 461 that is desired to be used by application 2 405B). In step 3.5, the target service 461 may perform a check to determine whether the credential (obtained from the target ICSGW 459) is associated with sufficient privileges to perform the requested action (i.e., fetch a message from the SQS queue). Further, as application 2 405B is associated with the access role that has read priviliages, the message is fetched from the SQS queue in the customer's tenancy 463 in step 3.5.

Referring now to flow 4 that corresponds to the scenrio of application 2 405B invoking a call to the S3 service to fetch an object from an S3 bucket. In step 4.1, application 2 405B issues a request to fetch the object from the S3 bucket. The request is forwarded to the source ICSGW 407 via the ICSGW 2 endpoint 406B. The source ICSGW 407 terminates the request and performs a validation check as described above. Upon successful validation, the source ICSGW 407 modifies the request to include the access role (e.g., IAM role 2) associated with application 2 405B in the request. The source ICSGW 407 forwards the modified request to the target ICSGW 459 in step 4.2. In step 4.3, the target ICSGW 459 extracts the corresponding access role from the modified request received from the source ICSGW 407. The target ICSGW 459 communicates with the management service to obtain a credential associated with the access role. In step 4.4, the target ICSGW 459 signs the modified request with the obtained credentials (of step 4.3) and forwards the signed request to the service (e.g., S3 service 461 that is desired to be used by application 2 405B). In step 4.5, the target service 461 may perform a check to determine whether the credential (obtained from the target ICSGW 459) is associated with sufficient privileges to perform the requested action (i.e., fetch an object from the S3 bucket). Further, as application 2 405B is associated with the access role that has read priviliages, the object is fetched from the S3 bucket in the customer's tenancy 463 in step 4.5.

Referring now to FIG. 4B, there is described in detail flow pertaining to four different requests (for services offered by the target cloud environment) that are issued by compute instances included in the customer VCN 403. Specifically, flow 5 (having steps labeled 5.1 to 5.4) corresponds to the scenrio of application 2 405B issuing a request to upload a file in the S3 bucket. Flow 6 (having steps labeled 6.1 to 6.4) corresponds to the scenrio of application 2 405B issuing a request to delete a message from the SQS queue. Flow 7 (having steps labeled 7.1 to 7.5) corresponds to the scenrio of application 1 405A issuing a request to delete a message from the SQS queue, and flow 8 (having steps labeled 8.1 to 8.5) corresponds to the scenrio of application 1 405A issuing a request to delete a file from the S3 bucket.

Referring now to flow 5 that corresponds to the scenrio of application 2 405B issuing a request to upload a file in the S3 bucket. In step 5.1, application 2 405B issues the request to upload a file in the S3 bucket. The request is forwarded to the source ICSGW 407 via the ICSGW 2 endpoint 406B. The source ICSGW 407 terminates the request and performs a validation check as described above. Upon successful validation, the source ICSGW 407 modifies the request to include the access role (e.g., IAM role 2) associated with application 2 405B in the request. The source ICSGW 407 forwards the modified request to the target ICSGW 459 in step 5.2. In step 5.3, the target ICSGW 459 extracts the corresponding access role from the modified request received from the source ICSGW 407. The target ICSGW 459 communicates with the management service to obtain a credential associated with the access role. In step 5.4, the target ICSGW 459 signs the modified request with the obtained credentials (of step 5.3) and forwards the signed request to the service (e.g., S3 service 461 that is desired to be used by application 2 405B). The target service 461 perform a check to determine whether the credential (obtained from the target ICSGW 459) is associated with sufficient privileges to perform the requested action (i.e., upload the file to S3 bucket). As application 2 405B is associated with the access role that has read only priviliages, S3 service in the target cloud environment denies the reqeust to upload the file in the S3 bucket (step 5.4). Thus, the request is not executed by the service 461 in the customer's account 463.

Referring now to flow 6 that corresponds to the scenrio of application 2 405B issuing a request to delete a message from the SQS queue. In step 6.1, application 2 405B issues the request to delete a message from the SQS queue. The request is forwarded to the source ICSGW 407 via the ICSGW 2 endpoint 406B. The source ICSGW 407 terminates the request and performs a validation check as described above. Upon successful validation, the source ICSGW 407 modifies the request to include the access role (e.g., IAM role 2) associated with application 2 405B in the request. The source ICSGW 407 forwards the modified request to the target ICSGW 459 in step 6.2. In step 6.3, the target ICSGW 459 extracts the corresponding access role from the modified request received from the source ICSGW 407. The target ICSGW 459 communicates with the management service to obtain a credential associated with the access role. In step 6.4, the target ICSGW 459 signs the modified request with the obtained credentials (of step 6.3) and forwards the signed request to the service (e.g., SQS service 461 that is desired to be used by application 2 405B). The target service 461 perform a check to determine whether the credential (obtained from the target ICSGW 459) is associated with sufficient privileges to perform the requested action (i.e., delete a message from the SQS queue). As application 2 405B is associated with the access role that has read only priviliages, SQS service in the target cloud environment denies the reqeust to delete the message (step 6.4). Thus, the request is not executed by the service 461 in the customer's account 463.

Turning now to flow 7, in step 7.1, application 1 405A issues a request to delete a message from the SQS queue. The request is forwarded to the source ICSGW 407 via the ICSGW 1 endpoint 406A. The source ICSGW 407 terminates the request and performs a validation check to determine whether the identity principal associated with application 1 405A is permitted to make such a request. Upon successful validation, the source ICSGW 407 modifies the request to include the access role (e.g., IAM role 1) associated with application 1 405A in the request. The source ICSGW 407 forwards the modified request to the target ICSGW 459 in step 7.2. In step 7.3, the target ICSGW 459 extracts the corresponding access role from the modified request received from the source ICSGW 407. The target ICSGW 459 communicates with the management service of the target cloud environment (e.g., secure token service 453B included in the target cloud services 453) to obtain a credential associated with the access role. In step 7.4, the target ICSGW 459 signs the modified request with the obtained credentials (of step 7.3) and forwards the signed request to the service (e.g., SQS service 461 that is desired to be used by application 1 405A). In step 7.5, the target service 461 may perform a check to determine whether the credential (obtained from the target ICSGW 459) is associated with sufficient privileges to perform the requested action (i.e., delete a message). Further, as application 1 405A is associated with the access role that has read and write priviliages, the message is deleted from the SQS queue in the customer's tenancy 463 in step 7.5.

Flow 8 (having steps labeled 8.1 to 8.5) corresponds to the scenrio of application 1 405A issuing a request to delete a file from the S3 bucket. In step 8.1, application 1 405A issues a request to delete a file from the S3 bucket. The request is forwarded to the source ICSGW 407 via the ICSGW 1 endpoint 406A. The source ICSGW 407 terminates the request and performs a validation check to determine whether the identity principal associated with application 1 405A is permitted to make such a request. Upon successful validation, the source ICSGW 407 modifies the request to include the access role (e.g., IAM role 1) associated with application 1 405A in the request. The source ICSGW 407 forwards the modified request to the target ICSGW 459 in step 8.2. In step 8.3, the target ICSGW 459 extracts the corresponding access role from the modified request received from the source ICSGW 407. The target ICSGW 459 communicates with the management service of the target cloud environment (e.g., secure token service 453B included in the target cloud services 453) to obtain a credential associated with the access role. In step 8.4, the target ICSGW 459 signs the modified request with the obtained credentials (of step 8.3) and forwards the signed request to the service (e.g., S3 service 461 that is desired to be used by application 1 405A). In step 8.5, the target service 461 performs a check to determine whether the credential (obtained from the target ICSGW 459) is associated with sufficient privileges to perform the requested action (i.e., delete a file from an S3 bucket). Further, as application 1 405A is associated with the access role that has read and write priviliages, the message is deleted from the S3 bucket in the customer's tenancy 463 in step 8.5.

Note that the exemplary scenarios depcited in FIGS. 4A and 4B correspond to the case of the customer having a tenenacy, i.e., customer account in the target cloud environment (e.g., customer B tenancy 335 of FIG. 3A). In this case, the ICSGW service account 337 is configured to manage services (in the target cloud environment) on behalf of compute instances that are executed in the source cloud environment. It is appreciated that a similar set of scenarios may be implemented for the case of the customer having no tenancy in the target cloud environment. In such a case, the ICSGW control plane (305 in FIG. 3A) may be configured to setup a customer resource group (e.g., customer A resource group 341) within the ICSGW service account 337 of the target cloud environment.

### Example Cloud Infrastructures

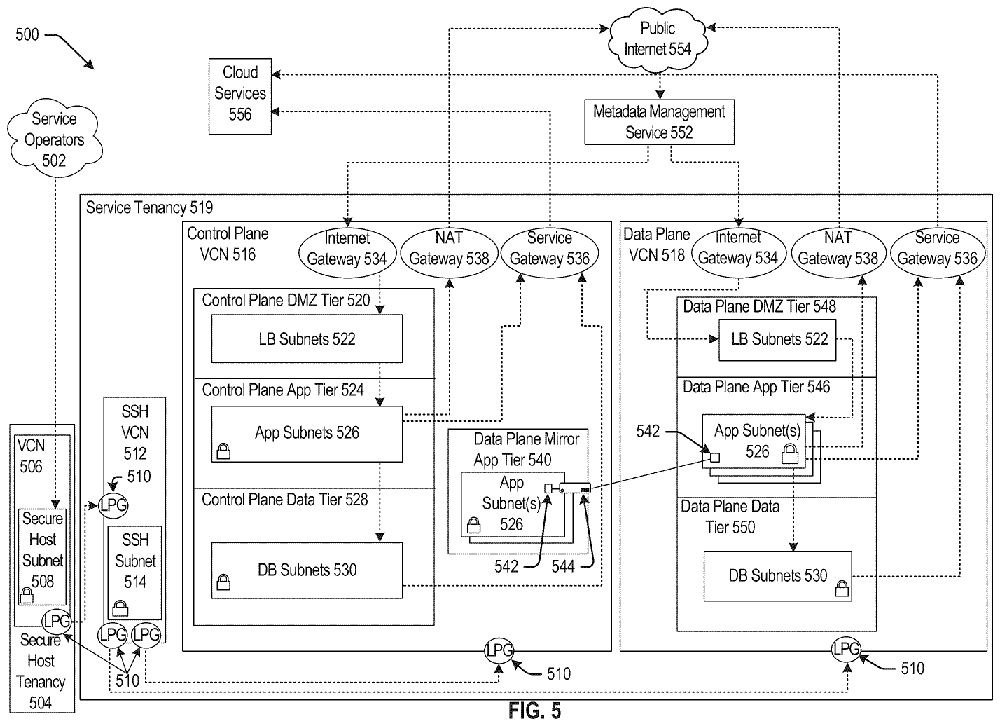

FIG. 5 is a block diagram 500 illustrating an example pattern of an IaaS architecture, according to at least one embodiment. Service operators 502 can be communicatively coupled to a secure host tenancy 504 that can include a virtual cloud network (VCN) 506 and a secure host subnet 508. In some examples, the service operators 502 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 506 and/or the Internet.

The VCN 506 can include a local peering gateway (LPG) 510 that can be communicatively coupled to a secure shell (SSH) VCN 512 via an LPG 510 contained in the SSH VCN 512. The SSH VCN 512 can include an SSH subnet 514, and the SSH VCN 512 can be communicatively coupled to a control plane VCN 516 via the LPG 510 contained in the control plane VCN 516. Also, the SSH VCN 512 can be communicatively coupled to a data plane VCN 518 via an LPG 510. The control plane VCN 516 and the data plane VCN 518 can be contained in a service tenancy 519 that can be owned and/or operated by the IaaS provider.

The control plane VCN 516 can include a control plane demilitarized zone (DMZ) tier 520 that acts as a perimeter network (e.g., portions of a corporate network between the corporate intranet and external networks). The DMZ-based servers may have restricted responsibilities and help keep security breaches contained. Additionally, the DMZ tier 520 can include one or more load balancer (LB) subnet(s) 522, a control plane app tier 524 that can include app subnet(s) 526, a control plane data tier 528 that can include database (DB) subnet(s) 530 (e.g., frontend DB subnet(s) and/or backend DB subnet(s)). The LB subnet(s) 522 contained in the control plane DMZ tier 520 can be communicatively coupled to the app subnet(s) 526 contained in the control plane app tier 524 and an Internet gateway 534 that can be contained in the control plane VCN 516, and the app subnet(s) 526 can be communicatively coupled to the DB subnet(s) 530 contained in the control plane data tier 528 and a service gateway 536 and a network address translation (NAT) gateway 538. The control plane VCN 516 can include the service gateway 536 and the NAT gateway 538.

The control plane VCN 516 can include a data plane mirror app tier 540 that can include app subnet(s) 526. The app subnet(s) 526 contained in the data plane mirror app tier 540 can include a virtual network interface controller (VNIC) 542 that can execute a compute instance 544. The compute instance 544 can communicatively couple the app subnet(s) 526 of the data plane mirror app tier 540 to app subnet(s) 526 that can be contained in a data plane app tier 546.

The data plane VCN 518 can include the data plane app tier 546, a data plane DMZ tier 548, and a data plane data tier 550. The data plane DMZ tier 548 can include LB subnet(s) 522 that can be communicatively coupled to the app subnet(s) 526 of the data plane app tier 546 and the Internet gateway 534 of the data plane VCN 518. The app subnet(s) 526 can be communicatively coupled to the service gateway 536 of the data plane VCN 518 and the NAT gateway 538 of the data plane VCN 518. The data plane data tier 550 can also include the DB subnet(s) 530 that can be communicatively coupled to the app subnet(s) 526 of the data plane app tier 546.

The Internet gateway 534 of the control plane VCN 516 and of the data plane VCN 518 can be communicatively coupled to a metadata management service 552 that can be communicatively coupled to public Internet 554. Public Internet 554 can be communicatively coupled to the NAT gateway 538 of the control plane VCN 516 and of the data plane VCN 518. The service gateway 536 of the control plane VCN 516 and of the data plane VCN 518 can be communicatively couple to cloud services 556.

In some examples, the service gateway 536 of the control plane VCN 516 or of the data plane VCN 518 can make application programming interface (API) calls to cloud services 556 without going through public Internet 554. The API calls to cloud services 556 from the service gateway 536 can be one-way: the service gateway 536 can make API calls to cloud services 556, and cloud services 556 can send requested data to the service gateway 536. But, cloud services 556 may not initiate API calls to the service gateway 536.

In some examples, the secure host tenancy 504 can be directly connected to the service tenancy 519, which may be otherwise isolated. The secure host subnet 508 can communicate with the SSH subnet 514 through an LPG 510 that may enable two-way communication over an otherwise isolated system. Connecting the secure host subnet 508 to the SSH subnet 514 may give the secure host subnet 508 access to other entities within the service tenancy 519.

The control plane VCN 516 may allow users of the service tenancy 519 to set up or otherwise provision desired resources. Desired resources provisioned in the control plane VCN 516 may be deployed or otherwise used in the data plane VCN 518. In some examples, the control plane VCN 516 can be isolated from the data plane VCN 518, and the data plane mirror app tier 540 of the control plane VCN 516 can communicate with the data plane app tier 546 of the data plane VCN 518 via VNICs 542 that can be contained in the data plane mirror app tier 540 and the data plane app tier 546.

In some examples, users of the system, or customers, can make requests, for example create, read, update, or delete (CRUD) operations, through public Internet 554 that can communicate the requests to the metadata management service 552. The metadata management service 552 can communicate the request to the control plane VCN 516 through the Internet gateway 534. The request can be received by the LB subnet(s) 522 contained in the control plane DMZ tier 520. The LB subnet(s) 522 may determine that the request is valid, and in response to this determination, the LB subnet(s) 522 can transmit the request to app subnet(s) 526 contained in the control plane app tier 524. If the request is validated and requires a call to public Internet 554, the call to public Internet 554 may be transmitted to the NAT gateway 538 that can make the call to public Internet 554. Memory that may be desired to be stored by the request can be stored in the DB subnet(s) 530.

In some examples, the data plane mirror app tier 540 can facilitate direct communication between the control plane VCN 516 and the data plane VCN 518. For example, changes, updates, or other suitable modifications to configuration may be desired to be applied to the resources contained in the data plane VCN 518. Via a VNIC 542, the control plane VCN 516 can directly communicate with, and can thereby execute the changes, updates, or other suitable modifications to configuration to, resources contained in the data plane VCN 518.

In some embodiments, the control plane VCN 516 and the data plane VCN 518 can be contained in the service tenancy 519. In this case, the user, or the customer, of the system may not own or operate either the control plane VCN 516 or the data plane VCN 518. Instead, the IaaS provider may own or operate the control plane VCN 516 and the data plane VCN 518, both of which may be contained in the service tenancy 519. This embodiment can enable isolation of networks that may prevent users or customers from interacting with other users', or other customers', resources. Also, this embodiment may allow users or customers of the system to store databases privately without needing to rely on public Internet 654, which may not have a desired level of security, for storage.

In other embodiments, the LB subnet(s) 522 contained in the control plane VCN 516 can be configured to receive a signal from the service gateway 536. In this embodiment, the control plane VCN 516 and the data plane VCN 518 may be configured to be called by a customer of the IaaS provider without calling public Internet 554. Customers of the IaaS provider may desire this embodiment since database(s) that the customers use may be controlled by the IaaS provider and may be stored on the service tenancy 519, which may be isolated from public Internet 554.

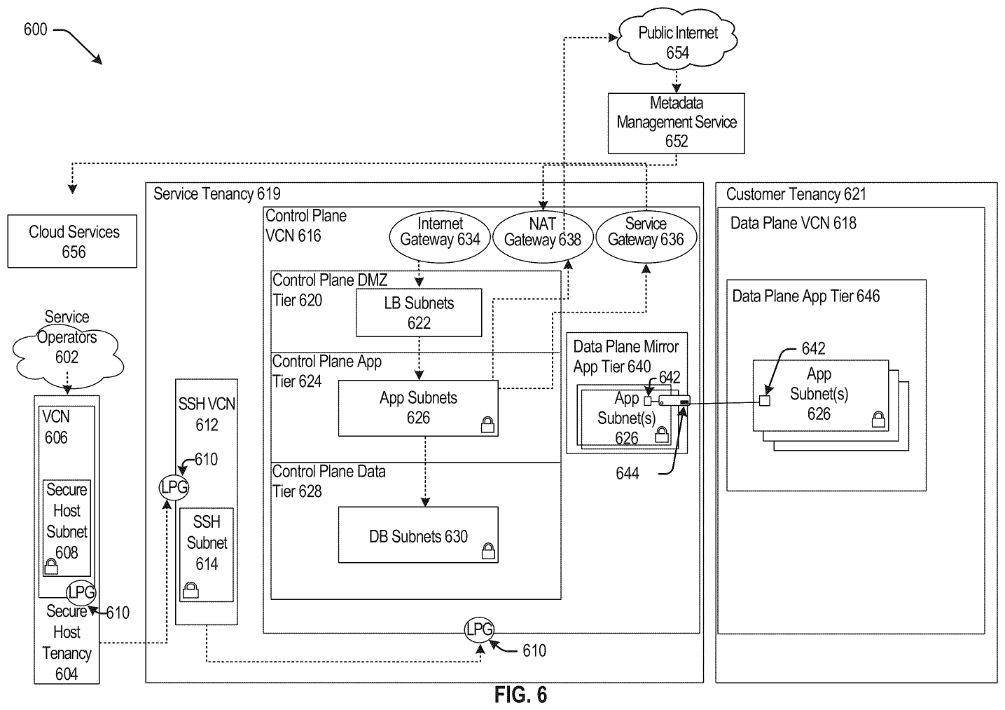

FIG. 6 is a block diagram 600 illustrating another example pattern of an IaaS architecture, according to at least one embodiment. Service operators 602 (e.g. service operators 502 of FIG. 5) can be communicatively coupled to a secure host tenancy 604 (e.g. the secure host tenancy 504 of FIG. 5) that can include a virtual cloud network (VCN) 606 (e.g. the VCN 506 of FIG. 5) and a secure host subnet 608 (e.g. the secure host subnet 508 of FIG. 5). The VCN 606 can include a local peering gateway (LPG) 610 (e.g. the LPG 510 of FIG. 5) that can be communicatively coupled to a secure shell (SSH) VCN 612 (e.g. the SSH VCN 512 of FIG. 5) via an LPG 510 contained in the SSH VCN 612. The SSH VCN 612 can include an SSH subnet 614 (e.g. the SSH subnet 514 of FIG. 5), and the SSH VCN 612 can be communicatively coupled to a control plane VCN 616 (e.g. the control plane VCN 516 of FIG. 5) via an LPG 610 contained in the control plane VCN 616. The control plane VCN 616 can be contained in a service tenancy 619 (e.g. the service tenancy 519 of FIG. 5), and the data plane VCN 618 (e.g. the data plane VCN 518 of FIG. 5) can be contained in a customer tenancy 621 that may be owned or operated by users, or customers, of the system.

The control plane VCN 616 can include a control plane DMZ tier 620 (e.g. the control plane DMZ tier 520 of FIG. 5) that can include LB subnet(s) 622 (e.g. LB subnet(s) 522 of FIG. 5), a control plane app tier 624 (e.g. the control plane app tier 524 of FIG. 5) that can include app subnet(s) 626 (e.g. app subnet(s) 526 of FIG. 5), a control plane data tier 628 (e.g. the control plane data tier 528 of FIG. 5) that can include database (DB) subnet(s) 630 (e.g. similar to DB subnet(s) 530 of FIG. 5). The LB subnet(s) 622 contained in the control plane DMZ tier 620 can be communicatively coupled to the app subnet(s) 626 contained in the control plane app tier 624 and an Internet gateway 634 (e.g. the Internet gateway 534 of FIG. 5) that can be contained in the control plane VCN 616, and the app subnet(s) 626 can be communicatively coupled to the DB subnet(s) 630 contained in the control plane data tier 628 and a service gateway 636 (e.g. the service gateway of FIG. 5) and a network address translation (NAT) gateway 638 (e.g. the NAT gateway 538 of FIG. 5). The control plane VCN 616 can include the service gateway 636 and the NAT gateway 638.

The control plane VCN 616 can include a data plane mirror app tier 640 (e.g. the data plane mirror app tier 540 of FIG. 5) that can include app subnet(s) 626. The app subnet(s) 626 contained in the data plane mirror app tier 640 can include a virtual network interface controller (VNIC) 642 (e.g. the VNIC of 542) that can execute a compute instance 644 (e.g. similar to the compute instance 544 of FIG. 5). The compute instance 644 can facilitate communication between the app subnet(s) 626 of the data plane mirror app tier 640 and the app subnet(s) 626 that can be contained in a data plane app tier 646 (e.g. the data plane app tier 546 of FIG. 5) via the VNIC 642 contained in the data plane mirror app tier 640 and the VNIC 642 contained in the data plane app tier 646.

The Internet gateway 634 contained in the control plane VCN 616 can be communicatively coupled to a metadata management service 652 (e.g. the metadata management service 552 of FIG. 5) that can be communicatively coupled to public Internet 654 (e.g. public Internet 554 of FIG. 5). Public Internet 654 can be communicatively coupled to the NAT gateway 638 contained in the control plane VCN 616. The service gateway 636 contained in the control plane VCN 616 can be communicatively couple to cloud services 656 (e.g. cloud services 556 of FIG. 5).

In some examples, the data plane VCN 618 can be contained in the customer tenancy 621. In this case, the IaaS provider may provide the control plane VCN 616 for each customer, and the IaaS provider may, for each customer, set up a unique compute instance 644 that is contained in the service tenancy 619. Each compute instance 644 may allow communication between the control plane VCN 616, contained in the service tenancy 619, and the data plane VCN 618 that is contained in the customer tenancy 621. The compute instance 644 may allow resources, that are provisioned in the control plane VCN 616 that is contained in the service tenancy 619, to be deployed or otherwise used in the data plane VCN 618 that is contained in the customer tenancy 621.

In other examples, the customer of the IaaS provider may have databases that live in the customer tenancy 621. In this example, the control plane VCN 616 can include the data plane mirror app tier 640 that can include app subnet(s) 626. The data plane mirror app tier 640 can reside in the data plane VCN 618, but the data plane mirror app tier 640 may not live in the data plane VCN 618. That is, the data plane mirror app tier 640 may have access to the customer tenancy 621, but the data plane mirror app tier 640 may not exist in the data plane VCN 618 or be owned or operated by the customer of the IaaS provider. The data plane mirror app tier 640 may be configured to make calls to the data plane VCN 618 but may not be configured to make calls to any entity contained in the control plane VCN 616. The customer may desire to deploy or otherwise use resources in the data plane VCN 618 that are provisioned in the control plane VCN 616, and the data plane mirror app tier 640 can facilitate the desired deployment, or other usage of resources, of the customer.

In some embodiments, the customer of the IaaS provider can apply filters to the data plane VCN 618. In this embodiment, the customer can determine what the data plane VCN 618 can access, and the customer may restrict access to public Internet 654 from the data plane VCN 618. The IaaS provider may not be able to apply filters or otherwise control access of the data plane VCN 618 to any outside networks or databases. Applying filters and controls by the customer onto the data plane VCN 618, contained in the customer tenancy 621, can help isolate the data plane VCN 618 from other customers and from public Internet 654.

In some embodiments, cloud services 656 can be called by the service gateway 636 to access services that may not exist on public Internet 654, on the control plane VCN 616, or on the data plane VCN 618. The connection between cloud services 656 and the control plane VCN 616 or the data plane VCN 618 may not be live or continuous. Cloud services 656 may exist on a different network owned or operated by the IaaS provider. Cloud services 656 may be configured to receive calls from the service gateway 636 and may be configured to not receive calls from public Internet 654. Some cloud services 656 may be isolated from other cloud services 656, and the control plane VCN 616 may be isolated from cloud services 656 that may not be in the same region as the control plane VCN 616. For example, the control plane VCN 616 may be located in “Region 1,” and cloud service “Deployment 6,” may be located in Region 1 and in “Region 2.” If a call to Deployment 6 is made by the service gateway 636 contained in the control plane VCN 616 located in Region 1, the call may be transmitted to Deployment 6 in Region 1. In this example, the control plane VCN 616, or Deployment 6 in Region 1, may not be communicatively coupled to, or otherwise in communication with, Deployment 6 in Region 2.

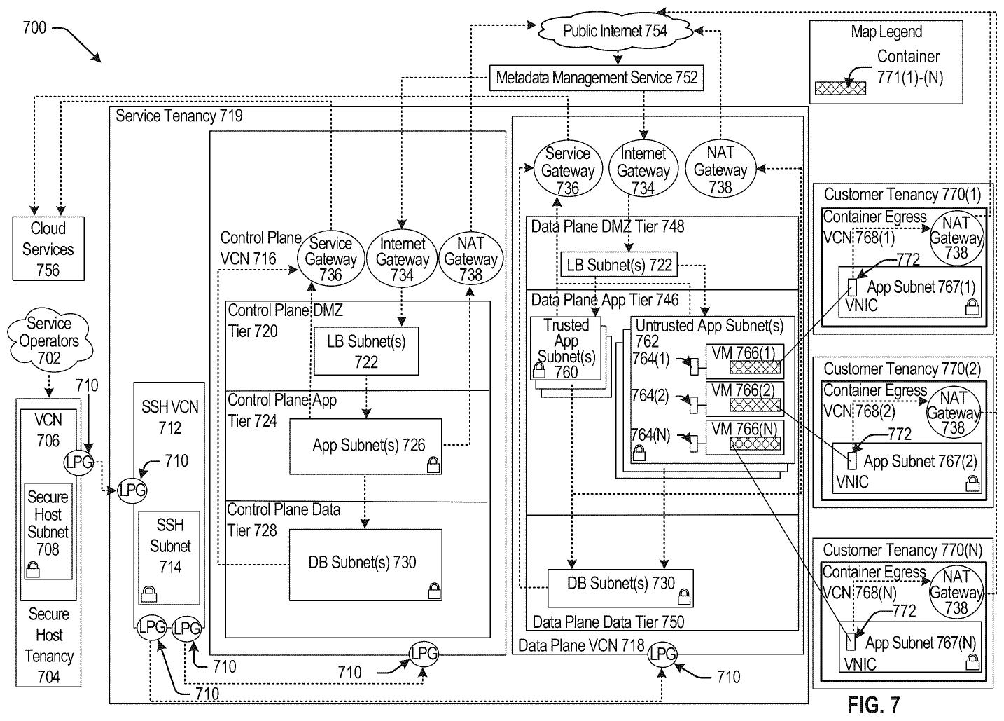

FIG. 7 is a block diagram 700 illustrating another example pattern of an IaaS architecture, according to at least one embodiment. Service operators 702 (e.g. service operators 502 of FIG. 5) can be communicatively coupled to a secure host tenancy 704 (e.g. the secure host tenancy 504 of FIG. 5) that can include a virtual cloud network (VCN) 706 (e.g. the VCN 506 of FIG. 5) and a secure host subnet 708 (e.g. the secure host subnet 508 of FIG. 5). The VCN 706 can include an LPG 710 (e.g. the LPG 510 of FIG. 5) that can be communicatively coupled to an SSH VCN 712 (e.g. the SSH VCN 512 of FIG. 5) via an LPG 710 contained in the SSH VCN 712. The SSH VCN 712 can include an SSH subnet 714 (e.g. the SSH subnet 514 of FIG. 5), and the SSH VCN 712 can be communicatively coupled to a control plane VCN 716 (e.g. the control plane VCN 516 of FIG. 5) via an LPG 710 contained in the control plane VCN 716 and to a data plane VCN 718 (e.g. the data plane 518 of FIG. 5) via an LPG 710 contained in the data plane VCN 718. The control plane VCN 716 and the data plane VCN 718 can be contained in a service tenancy 719 (e.g. the service tenancy 519 of FIG. 5).

The control plane VCN 716 can include a control plane DMZ tier 720 (e.g. the control plane DMZ tier 520 of FIG. 5) that can include load balancer (LB) subnet(s) 722 (e.g. LB subnet(s) 522 of FIG. 5), a control plane app tier 724 (e.g. the control plane app tier 524 of FIG. 5) that can include app subnet(s) 726 (e.g. similar to app subnet(s) 526 of FIG. 5), a control plane data tier 728 (e.g. the control plane data tier 528 of FIG. 5) that can include DB subnet(s) 730. The LB subnet(s) 722 contained in the control plane DMZ tier 720 can be communicatively coupled to the app subnet(s) 726 contained in the control plane app tier 724 and to an Internet gateway 734 (e.g. the Internet gateway 534 of FIG. 5) that can be contained in the control plane VCN 716, and the app subnet(s) 726 can be communicatively coupled to the DB subnet(s) 730 contained in the control plane data tier 728 and to a service gateway 736 (e.g. the service gateway of FIG. 5) and a network address translation (NAT) gateway 738 (e.g. the NAT gateway 538 of FIG. 5). The control plane VCN 716 can include the service gateway 736 and the NAT gateway 738.

The data plane VCN 718 can include a data plane app tier 746 (e.g. the data plane app tier 546 of FIG. 5), a data plane DMZ tier 748 (e.g. the data plane DMZ tier 548 of FIG. 5), and a data plane data tier 750 (e.g. the data plane data tier 550 of FIG. 5). The data plane DMZ tier 748 can include LB subnet(s) 722 that can be communicatively coupled to trusted app subnet(s) 760 and untrusted app subnet(s) 762 of the data plane app tier 746 and the Internet gateway 734 contained in the data plane VCN 718. The trusted app subnet(s) 760 can be communicatively coupled to the service gateway 736 contained in the data plane VCN 718, the NAT gateway 738 contained in the data plane VCN 718, and DB subnet(s) 730 contained in the data plane data tier 750. The untrusted app subnet(s) 762 can be communicatively coupled to the service gateway 736 contained in the data plane VCN 718 and DB subnet(s) 730 contained in the data plane data tier 750. The data plane data tier 750 can include DB subnet(s) 730 that can be communicatively coupled to the service gateway 736 contained in the data plane VCN 718.

The untrusted app subnet(s) 762 can include one or more primary VNICs 764(1)-(N) that can be communicatively coupled to tenant virtual machines (VMs) 766(1)-(N). Each tenant VM 766(1)-(N) can be communicatively coupled to a respective app subnet 767(1)-(N) that can be contained in respective container egress VCNs 768(1)-(N) that can be contained in respective customer tenancies 770(1)-(N). Respective secondary VNICs 772(1)-(N) can facilitate communication between the untrusted app subnet(s) 762 contained in the data plane VCN 718 and the app subnet contained in the container egress VCNs 768(1)-(N). Each container egress VCNs 768(1)-(N) can include a NAT gateway 738 that can be communicatively coupled to public Internet 754 (e.g. public Internet 554 of FIG. 5).

The Internet gateway 734 contained in the control plane VCN 716 and contained in the data plane VCN 718 can be communicatively coupled to a metadata management service 752 (e.g. the metadata management system 552 of FIG. 5) that can be communicatively coupled to public Internet 754. Public Internet 754 can be communicatively coupled to the NAT gateway 738 contained in the control plane VCN 716 and contained in the data plane VCN 718. The service gateway 736 contained in the control plane VCN 716 and contained in the data plane VCN 718 can be communicatively couple to cloud services 756.

In some embodiments, the data plane VCN 718 can be integrated with customer tenancies 770. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 746. Code to run the function may be executed in the VMs 766(1)-(N), and the code may not be configured to run anywhere else on the data plane VCN 718. Each VM 766(1)-(N) may be connected to one customer tenancy 770. Respective containers 771(1)-(N) contained in the VMs 766(1)-(N) may be configured to run the code. In this case, there can be a dual isolation (e.g., the containers 771(1)-(N) running code, where the containers 771(1)-(N) may be contained in at least the VM 766(1)-(N) that are contained in the untrusted app subnet(s) 762), which may help prevent incorrect or otherwise undesirable code from damaging the network of the IaaS provider or from damaging a network of a different customer. The containers 771(1)-(N) may be communicatively coupled to the customer tenancy 770 and may be configured to transmit or receive data from the customer tenancy 770. The containers 771(1)-(N) may not be configured to transmit or receive data from any other entity in the data plane VCN 718. Upon completion of running the code, the IaaS provider may kill or otherwise dispose of the containers 771(1)-(N).

In some embodiments, the trusted app subnet(s) 760 may run code that may be owned or operated by the IaaS provider. In this embodiment, the trusted app subnet(s) 760 may be communicatively coupled to the DB subnet(s) 730 and be configured to execute CRUD operations in the DB subnet(s) 730. The untrusted app subnet(s) 762 may be communicatively coupled to the DB subnet(s) 730, but in this embodiment, the untrusted app subnet(s) may be configured to execute read operations in the DB subnet(s) 730. The containers 771(1)-(N) that can be contained in the VM 766(1)-(N) of each customer and that may run code from the customer may not be communicatively coupled with the DB subnet(s) 730.

In other embodiments, the control plane VCN 716 and the data plane VCN 718 may not be directly communicatively coupled. In this embodiment, there may be no direct communication between the control plane VCN 716 and the data plane VCN 718. However, communication can occur indirectly through at least one method. An LPG 710 may be established by the IaaS provider that can facilitate communication between the control plane VCN 716 and the data plane VCN 718. In another example, the control plane VCN 716 or the data plane VCN 718 can make a call to cloud services 756 via the service gateway 736. For example, a call to cloud services 756 from the control plane VCN 716 can include a request for a service that can communicate with the data plane VCN 718.

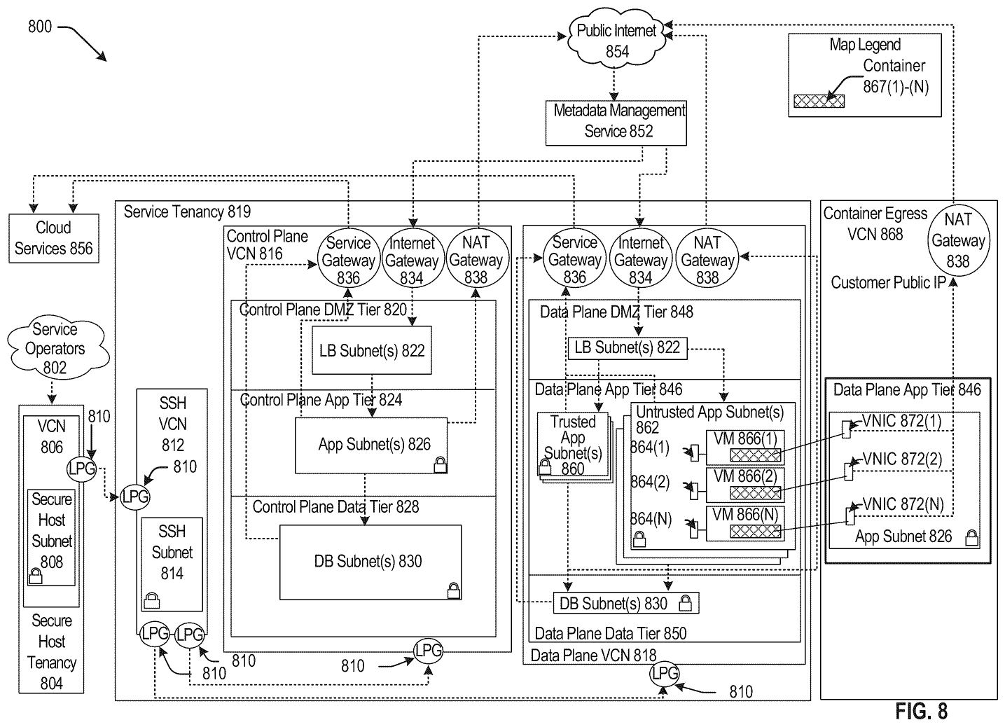

FIG. 8 is a block diagram 800 illustrating another example pattern of an IaaS architecture, according to at least one embodiment. Service operators 802 (e.g. service operators 502 of FIG. 5) can be communicatively coupled to a secure host tenancy 804 (e.g. the secure host tenancy 504 of FIG. 5) that can include a virtual cloud network (VCN) 806 (e.g. the VCN 506 of FIG. 5) and a secure host subnet 808 (e.g. the secure host subnet 508 of FIG. 5). The VCN 806 can include an LPG 810 (e.g. the LPG 510 of FIG. 5) that can be communicatively coupled to an SSH VCN 812 (e.g. the SSH VCN 512 of FIG. 5) via an LPG 810 contained in the SSH VCN 812. The SSH VCN 812 can include an SSH subnet 814 (e.g. the SSH subnet 514 of FIG. 5), and the SSH VCN 812 can be communicatively coupled to a control plane VCN 816 (e.g. the control plane VCN 516 of FIG. 5) via an LPG 810 contained in the control plane VCN 816 and to a data plane VCN 818 (e.g. the data plane 518 of FIG. 5) via an LPG 810 contained in the data plane VCN 818. The control plane VCN 816 and the data plane VCN 818 can be contained in a service tenancy 819 (e.g. the service tenancy 519 of FIG. 5).

The control plane VCN 816 can include a control plane DMZ tier 820 (e.g. the control plane DMZ tier 520 of FIG. 5) that can include LB subnet(s) 822 (e.g. LB subnet(s) 522 of FIG. 5), a control plane app tier 824 (e.g. the control plane app tier 524 of FIG. 5) that can include app subnet(s) 826 (e.g. app subnet(s) 526 of FIG. 5), a control plane data tier 828 (e.g. the control plane data tier 528 of FIG. 5) that can include DB subnet(s) 830 (e.g. DB subnet(s) 730 of FIG. 7). The LB subnet(s) 822 contained in the control plane DMZ tier 820 can be communicatively coupled to the app subnet(s) 826 contained in the control plane app tier 824 and to an Internet gateway 834 (e.g. the Internet gateway 534 of FIG. 5) that can be contained in the control plane VCN 816, and the app subnet(s) 826 can be communicatively coupled to the DB subnet(s) 830 contained in the control plane data tier 828 and to a service gateway 836 (e.g. the service gateway of FIG. 5) and a network address translation (NAT) gateway 838 (e.g. the NAT gateway 538 of FIG. 5). The control plane VCN 816 can include the service gateway 836 and the NAT gateway 838.

The data plane VCN 818 can include a data plane app tier 846 (e.g. the data plane app tier 546 of FIG. 5), a data plane DMZ tier 848 (e.g. the data plane DMZ tier 548 of FIG. 5), and a data plane data tier 850 (e.g. the data plane data tier 550 of FIG. 5). The data plane DMZ tier 848 can include LB subnet(s) 822 that can be communicatively coupled to trusted app subnet(s) 860 (e.g. trusted app subnet(s) 760 of FIG. 7) and untrusted app subnet(s) 862 (e.g. untrusted app subnet(s) 762 of FIG. 7) of the data plane app tier 846 and the Internet gateway 834 contained in the data plane VCN 818. The trusted app subnet(s) 860 can be communicatively coupled to the service gateway 836 contained in the data plane VCN 818, the NAT gateway 838 contained in the data plane VCN 818, and DB subnet(s) 830 contained in the data plane data tier 850. The untrusted app subnet(s) 862 can be communicatively coupled to the service gateway 836 contained in the data plane VCN 818 and DB subnet(s) 830 contained in the data plane data tier 850. The data plane data tier 850 can include DB subnet(s) 830 that can be communicatively coupled to the service gateway 836 contained in the data plane VCN 818.

The untrusted app subnet(s) 862 can include primary VNICs 864(1)-(N) that can be communicatively coupled to tenant virtual machines (VMs) 866(1)-(N) residing within the untrusted app subnet(s) 862. Each tenant VM 866(1)-(N) can run code in a respective container 867(1)-(N), and be communicatively coupled to an app subnet 826 that can be contained in a data plane app tier 846 that can be contained in a container egress VCN 868. Respective secondary VNICs 872(1)-(N) can facilitate communication between the untrusted app subnet(s) 862 contained in the data plane VCN 818 and the app subnet contained in the container egress VCN 868. The container egress VCN can include a NAT gateway 838 that can be communicatively coupled to public Internet 854 (e.g. public Internet 554 of FIG. 5).

The Internet gateway 834 contained in the control plane VCN 816 and contained in the data plane VCN 818 can be communicatively coupled to a metadata management service 852 (e.g. the metadata management system 552 of FIG. 5) that can be communicatively coupled to public Internet 854. Public Internet 854 can be communicatively coupled to the NAT gateway 838 contained in the control plane VCN 816 and contained in the data plane VCN 818. The service gateway 836 contained in the control plane VCN 816 and contained in the data plane VCN 818 can be communicatively couple to cloud services 856.

In some examples, the pattern illustrated by the architecture of block diagram 800 of FIG. 8 may be considered an exception to the pattern illustrated by the architecture of block diagram 600 of FIG. 6 and may be desirable for a customer of the IaaS provider if the IaaS provider cannot directly communicate with the customer (e.g., a disconnected region). The respective containers 867(1)-(N) that are contained in the VMs 866(1)-(N) for each customer can be accessed in real-time by the customer. The containers 867(1)-(N) may be configured to make calls to respective secondary VNICs 872(1)-(N) contained in app subnet(s) 826 of the data plane app tier 846 that can be contained in the container egress VCN 868. The secondary VNICs 872(1)-(N) can transmit the calls to the NAT gateway 838 that may transmit the calls to public Internet 854. In this example, the containers 867(1)-(N) that can be accessed in real-time by the customer can be isolated from the control plane VCN 816 and can be isolated from other entities contained in the data plane VCN 818. The containers 867(1)-(N) may also be isolated from resources from other customers.

In other examples, the customer can use the containers 867(1)-(N) to call cloud services 856. In this example, the customer may run code in the containers 867(1)-(N) that requests a service from cloud services 856. The containers 867(1)-(N) can transmit this request to the secondary VNICs 872(1)-(N) that can transmit the request to the NAT gateway that can transmit the request to public Internet 854. Public Internet 854 can transmit the request to LB subnet(s) 822 contained in the control plane VCN 816 via the Internet gateway 834. In response to determining the request is valid, the LB subnet(s) can transmit the request to app subnet(s) 826 that can transmit the request to cloud services 856 via the service gateway 836.

It should be appreciated that IaaS architectures 500, 600, 700, 800 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

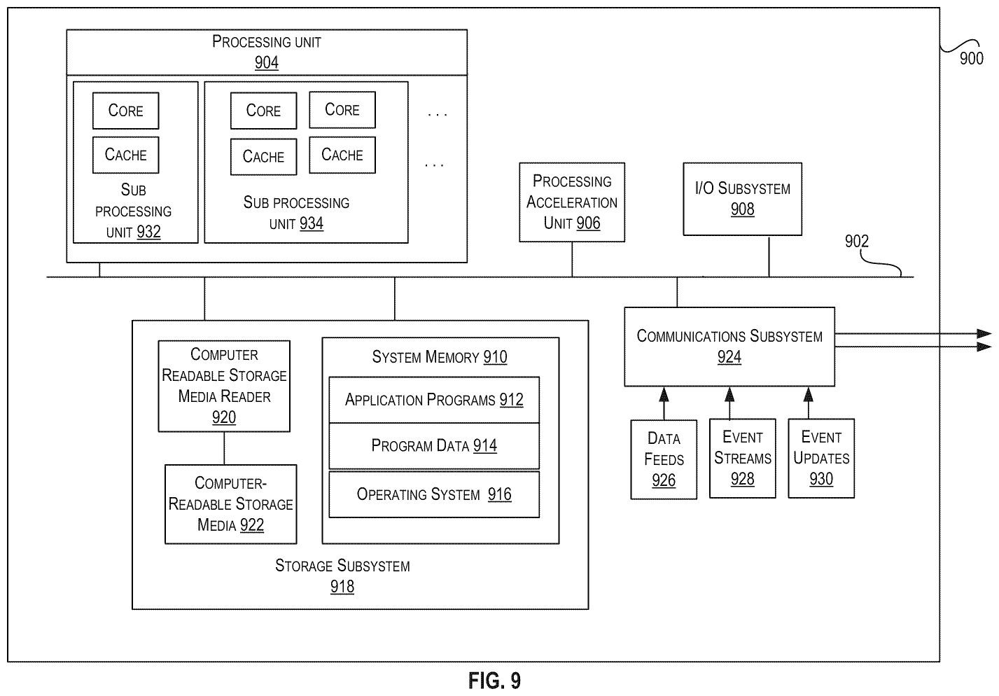

FIG. 9 illustrates an example computer system 900, in which various embodiments may be implemented. The system 900 may be used to implement any of the computer systems described above. As shown in the figure, computer system 900 includes a processing unit 904 that communicates with a number of peripheral subsystems via a bus subsystem 902. These peripheral subsystems may include a processing acceleration unit 906, an I/O subsystem 908, a storage subsystem 918 and a communications subsystem 924. Storage subsystem 918 includes tangible computer-readable storage media 922 and a system memory 910.

Bus subsystem 902 provides a mechanism for letting the various components and subsystems of computer system 900 communicate with each other as intended. Although bus subsystem 902 is shown schematically as a single bus, alternative embodiments of the bus subsystem may utilize multiple buses. Bus subsystem 902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 904, which can be implemented as one or more integrated circuits (e.g., a conventional microprocessor or microcontroller), controls the operation of computer system 900. One or more processors may be included in processing unit 904. These processors may include single core or multicore processors. In certain embodiments, processing unit 904 may be implemented as one or more independent processing units 932 and/or 934 with single or multicore processors included in each processing unit. In other embodiments, processing unit 904 may also be implemented as a quad-core processing unit formed by integrating two dual-core processors into a single chip.

In various embodiments, processing unit 904 can execute a variety of programs in response to program code and can maintain multiple concurrently executing programs or processes. At any given time, some or all of the program code to be executed can be resident in processor(s) 904 and/or in storage subsystem 918. Through suitable programming, processor(s) 904 can provide various functionalities described above. Computer system 900 may additionally include a processing acceleration unit 906, which can include a digital signal processor (DSP), a special-purpose processor, and/or the like.

I/O subsystem 908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 900 may comprise a storage subsystem 918 that comprises software elements, shown as being currently located within a system memory 910. System memory 910 may store program instructions that are loadable and executable on processing unit 904, as well as data generated during the execution of these programs.

Depending on the configuration and type of computer system 900, system memory 910 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 904. In some implementations, system memory 910 may include multiple different types of memory, such as static random access memory (SRAM) or dynamic random access memory (DRAM). In some implementations, a basic input/output system (BIOS), containing the basic routines that help to transfer information between elements within computer system 900, such as during start-up, may typically be stored in the ROM. By way of example, and not limitation, system memory 910 also illustrates application programs 912, which may include client applications, Web browsers, mid-tier applications, relational database management systems (RDBMS), etc., program data 914, and an operating system 916. By way of example, operating system 916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 918 may also provide a tangible computer-readable storage medium for storing the basic programming and data constructs that provide the functionality of some embodiments. Software (programs, code modules, instructions) that when executed by a processor provide the functionality described above may be stored in storage subsystem 918. These software modules or instructions may be executed by processing unit 904. Storage subsystem 918 may also provide a repository for storing data used in accordance with the present disclosure.

Storage subsystem 900 may also include a computer-readable storage media reader 920 that can further be connected to computer-readable storage media 922. Together and, optionally, in combination with system memory 910, computer-readable storage media 922 may comprehensively represent remote, local, fixed, and/or removable storage devices plus storage media for temporarily and/or more permanently containing, storing, transmitting, and retrieving computer-readable information.

Computer-readable storage media 922 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 900.

By way of example, computer-readable storage media 922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 922 may include, but is not limited to, Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 1000 to connect to one or more devices via the Internet. In some embodiments communications subsystem 924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 924 can provide wired network connectivity (e.g., Ethernet) in addition to or instead of a wireless interface.

In some embodiments, communications subsystem 924 may also receive input communication in the form of structured and/or unstructured data feeds 926, event streams 928, event updates 930, and the like on behalf of one or more users who may use computer system 900.

By way of example, communications subsystem 924 may be configured to receive data feeds 926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 924 may also be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 924 may also be configured to output the structured and/or unstructured data feeds 926, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method comprising:
generating, by a compute instance executed in a source cloud environment, a request to use a service provided in a target cloud environment, the source cloud environment being different than the target cloud environment;
transmitting the request from the source cloud environment to the target cloud environment via an intercloud service gateway; and
executing the service in the target cloud environment based on an access role associated with the compute instance.

2. The method of claim 1, further comprising:
sending, by the compute instance, the request to a source intercloud service gateway disposed in the source cloud environment, the request including an identity principal associated with the compute instance; and
validating, by the source intercloud service gateway, the identity principal of the compute instance.

3. The method of claim 2, wherein validating the identity principal includes verifying whether the compute instance is permitted to access the service in the target cloud environment.

4. The method of claim 2, further comprising:
responsive to the identity principal being successfully validated, obtaining, by the source intercloud service gateway, the access role associated with the compute instance from preconfigured information stored in the source cloud environment.

5. The method of claim 4, further comprising:
responsive to the identity principal being successfully validated, modifying the request by the source intercloud service gateway to generate a modified request, wherein the modifying includes removing the identity principal included in a metadata of the request, and incorporating the access role associated with the compute instance in the metadata; and
sending the modified request by the source intercloud service gateway to a target intercloud service gateway disposed in the target cloud environment.

6. The method of claim 5, wherein the source intercloud service gateway is disposed in a first data plane of the source cloud environment and the target intercloud service gateway is disposed in a second data plane of the target cloud environment, the source intercloud service gateway being communicatively coupled to the target intercloud service gateway via a trusted communication channel.

7. The method of claim 5, further comprising:
extracting, by the target intercloud service gateway, the access role associated with the compute instance from the modified request; and
obtaining, by the target intercloud service gateway, a token associated with the access role from a management service included in the target cloud environment.

8. The method of claim 7, further comprising:
signing, by the target intercloud service gateway, the modified request with the token associated with the access role to form a signed modified request; and
forwarding the signed modified request to the service that is desired to be used by the compute instance.

9. The method of claim 8, further comprising:
validating, by the service, the signed modified request based on the token; and
responsive to a successful validation, executing the request by the service.

10. A computer readable medium storing specific computer-executable instructions that, when executed by a processor, cause a computer system to at least:
generating, by a compute instance executed in a source cloud environment, a request to use a service provided in a target cloud environment, the source cloud environment being different than the target cloud environment;
transmitting the request from the source cloud environment to the target cloud environment via an intercloud service gateway; and
executing the service in the target cloud environment based on an access role associated with the compute instance.

11. The computer readable medium storing specific computer-executable instructions of claim 10, wherein the computer system is further configured for:
sending, by the compute instance, the request to a source intercloud service gateway disposed in the source cloud environment, the request including an identity principal associated with the compute instance; and
validating, by the source intercloud service gateway, the identity principal of the compute instance.

12. The computer readable medium storing specific computer-executable instructions of claim 11, wherein validating the identity principal includes verifying whether the compute instance is permitted to access the service in the target cloud environment.

13. The computer readable medium storing specific computer-executable instructions of claim 11, wherein the computer system is further configured for:
responsive to the identity principal being successfully validated, obtaining, by the source intercloud service gateway, the access role associated with the compute instance from preconfigured information stored in the source cloud environment.

14. The computer readable medium storing specific computer-executable instructions of claim 13, wherein the computer system is further configured for:
responsive to the identity principal being successfully validated, modifying the request by the source intercloud service gateway to generate a modified request, wherein the modifying includes removing the identity principal included in a metadata of the request, and incorporating the access role associated with the compute instance in the metadata; and
sending the modified request by the source intercloud service gateway to a target intercloud service gateway disposed in the target cloud environment.

15. The computer readable medium storing specific computer-executable instructions of claim 14, wherein the source intercloud service gateway is disposed in a first data plane of the source cloud environment and the target intercloud service gateway is disposed in a second data plane of the target cloud environment, the source intercloud service gateway being communicatively coupled to the target intercloud service gateway via a trusted communication channel.

16. The computer readable medium storing specific computer-executable instructions of claim 14, wherein the computer system is further configured for:
extracting, by the target intercloud service gateway, the access role associated with the compute instance from the modified request; and
obtaining, by the target intercloud service gateway, a token associated with the access role from a management service included in the target cloud environment.

17. The computer readable medium storing specific computer-executable instructions of claim 16, wherein the computer system is further configured for:
signing, by the target intercloud service gateway, the modified request with the token associated with the access role to form a signed modified request; and
forwarding the signed modified request to the service that is desired to be used by the compute instance.

18. A system comprising:
a processor; and
a memory including instructions that, when executed with the processor, cause the system to, at least:
generate, by a compute instance executed in a source cloud environment, a request to use a service provided in a target cloud environment, the source cloud environment being different than the target cloud environment;
transmit the request from the source cloud environment to the target cloud environment via an intercloud service gateway; and
execute the service in the target cloud environment based on an access role associated with the compute instance.

19. The system of claim 18, further configured to:
send, by the compute instance, the request to a source intercloud service gateway disposed in the source cloud environment, the request including an identity principal associated with the compute instance; and
validate, by the source intercloud service gateway, the identity principal of the compute instance.

20. The system of claim 19, wherein the system is configured to validate the identity principal by verifying whether the compute instance is permitted to access the service in the target cloud environment.
